(19) United States
(12) Patent Application Publication
(10) Pub. No.: US 2013/0135313 A1
(43) Pub. Date: May 30, 2013

(54) SYSTEMS AND METHODS OF DISPLAYING AND NAVIGATING CONTENT

(71) Applicants: George B. Gleadall, Boca Raton, FL (US); Shawn Stewart, Plantation, FL (US); Ronnie Paskin, Fort Lauderdale, FL (US)

(72) Inventors: George B. Gleadall, Boca Raton, FL (US); Shawn Stewart, Plantation, FL (US); Ronnie Paskin, Fort Lauderdale, FL (US)

(73) Assignee: CBS Interactive, Inc.

(21) Appl. No.: 13/308,332

(22) Filed: Nov. 30, 2011

(51) Int. Cl. G06T 11/20

(52) U.S. Cl. 345/440

(57) ABSTRACT

Systems and methods for displaying information, which include displaying, on a display, a first spatial representation of one or more nodes of a hierarchy of information, the first spatial representation including a first node. They further include receiving, at a processor, input. Additionally, they include displaying, on the display, a second spatial representation of one or more nodes of the hierarchy of information, based on the input. The second spatial representation includes a second node, which represents information that is related to information represented by the first node. In some implementations, whether, or the manner in which, each node of the one or more nodes is displayed in the first spatial representation is determined based at least in part on (a) how closely related the information represented by each node is to the information represented by the first node or (b) the popularity of information represented by each node.

### BACKGROUND

Internet web pages are traditionally displayed in snapshots of one web page at a time. In order to inform the user of additional pieces of information, two interfaces exist for the user: (1) hyperlinks to other web pages and (2) a search option which results in hyperlinks to other web pages. As these volumes of data grow, in some instances, exponentially with the advent of user-generated content and social networking, it becomes very difficult to present the entire volume of data to the user in a meaningful way, using traditional links. As a result, web site operators overload the top, bottom, and sides of web pages with links and provide search tools and filters to browse through a constantly growing volume of data.

There are many problems with this approach. It requires users to know what they are searching for prior to searching. Additionally, filters are an exercise in trial and error, because users do not automatically know how the information is categorized by the web site operators. If links are relied upon, web pages can become hard to use because they include too many links. Further, using static links requires web site operators to guess the information users would want to find.

### SUMMARY OF THE DISCLOSURE

Implementations of the systems and methods for displaying information are described herein. One implementation is a system including memory hardware storing program instructions. The system may further include one or more processors in data communication with the memory hardware that are configured to execute the program instructions. Upon execution of the program instructions, the one or more processors perform operations including providing display data representing a first spatial representation of one or more nodes of a hierarchy of information, the first spatial representation including a first node. The instructions, when processed by a processing circuit, further perform: receiving input and providing display data representing a second spatial representation of one or more nodes of the hierarchy of information, based on the input. The second spatial representation includes a second node, which represents information that is related to information represented by the first node. In some embodiments, the memory hardware is located on server(s) that transfer the program instructions to a client computing device for execution.

Another implementation is a method that includes displaying, on a display, a first spatial representation of one or more nodes of a hierarchy of information, the first spatial representation including a first node. The method further includes receiving, at a processor, input. Additionally, the method includes displaying, on the display, a second spatial representation of one or more nodes of the hierarchy of information, based on the input. The second spatial representation includes a second node, which represents information that is related to information represented by the first node.

Yet another implementation is a tangible computer-readable medium having instructions encoded thereon, such that the instructions, when processed by a processing circuit, display, on a display, a first spatial representation of one or more nodes of a hierarchy of information, the first spatial representation including a first node. The instructions, when processed by a processing circuit, further perform: receiving, at a processor, input; and displaying, on the display, a second spatial representation of one or more nodes of the hierarchy of information, based on the input. The second spatial representation includes a second node, which represents information that is related to information represented by the first node.

In some implementations, the second node is not displayed in the first spatial representation.

According to various implementations, the second node represents information that is at a same level of the hierarchy as the information represented by the first node. In various implementations, the second node represents information that is at a different level of the hierarchy than the information represented by the first node. In some of those implementations, the input includes selecting the first node.

In some implementations, whether, or the manner in which, each node of the one or more nodes is displayed in the first spatial representation is determined based at least in part on (a) how closely related the information represented by each node is to the information represented by the first node or (b) the popularity of information represented by each node. According to some implementations, a size or prominence of the first node in the first spatial representation depends at least in part on a popularity level of the information represented by the first node, and the size or prominence of the first node changes as the popularity level changes.

### BRIEF DESCRIPTION OF THE DRAWINGS

FIG. 1 is a schematic diagram of a system, according to an exemplary embodiment;

FIG. 2 illustrates a computer system for implementing a method of modifying data, according to an exemplary embodiment;

FIG. 3 is a flowchart of a method according to an exemplary embodiment, such that if input is received regarding selecting a node, node(s) are then displayed that are related to the selected node;

FIG. 4 is a flowchart of a method according to an exemplary embodiment, such that if input is received indicating that different node(s) should become the focus, different node(s) are then displayed;

FIG. 5A is an illustration of a monitor displaying a representation of nodes as displayed in an internet browser window, according to an exemplary embodiment;

FIG. 5B is an illustration of a monitor displaying a representation of nodes as displayed in an internet browser window, according to an exemplary embodiment, such that a node shown in FIG. 5A has been selected and its related nodes beneath it in the hierarchy are displayed;

FIG. 5C is an illustration of a monitor displaying a representation of nodes as displayed in an internet browser window, according to an exemplary embodiment, such that a particular node represents more popular information than a related node, and thus the particular node is displayed more prominently;

FIG. 6A is an illustration of a monitor displaying a representation of nodes at two levels in the hierarchy, as displayed in an application window, according to an exemplary embodiment;

FIG. 6B is an illustration of a monitor displaying a representation of nodes, as displayed in an application window, according to an exemplary embodiment, such that the higher-level nodes as displayed in FIG. 6A have been shifted to the left, thus bringing in different lower-level nodes into view; and

FIG. 6C is an illustration of a monitor displaying a representation of nodes at two levels in the hierarchy, as displayed in an application window, according to an exemplary embodiment, such that a lower-level node of FIG. 6B has been focused on, thus bringing even lower-level nodes into view.

### DETAILED DESCRIPTION OF EXEMPLARY EMBODIMENTS

One or more embodiments described herein may provide a way of displaying information. A server may transfer a file containing computer-executable code to a client device. This code may contain instructions to display a spatial representation of information. Specifically, the code may contain a spatial representation of nodes of a hierarchy of information. For example, a client computer may download a web page containing HTML and/or JavaScript from a web server and execute it in a World Wide Web browser, displaying the spatial representation. The spatial representation may appear to be, for instance, a map or mosaic of the content of a web site, database, file system, or network. Nodes in the map that represent related information may be connected or close to each other in proximity in the spatial representation.

The code may contain further instructions to adjust or change the spatial representation, according to input received. For example, based on the input, the spatial representation may change to appear to “zoom” in closer on a selected node, to allow the user to view more detailed information related to the selected node. As another example, based on the input, the spatial representation may change to appear to “scroll” or “pan” to the side (or up, down, etc.), to focus on other information outside the focus of the previous view.

This approach allows large volumes of data to be accessible to the user, while still allowing the user to easily navigate to the information desired. It also allows the user to quickly understand the relationships between portions of information. Additionally, nodes for popular information may be presented in the spatial representation differently from nodes for less popular information, to allow users to easily find information they are likely to be interested in. The methods and systems related to various embodiments are discussed in further detail below.

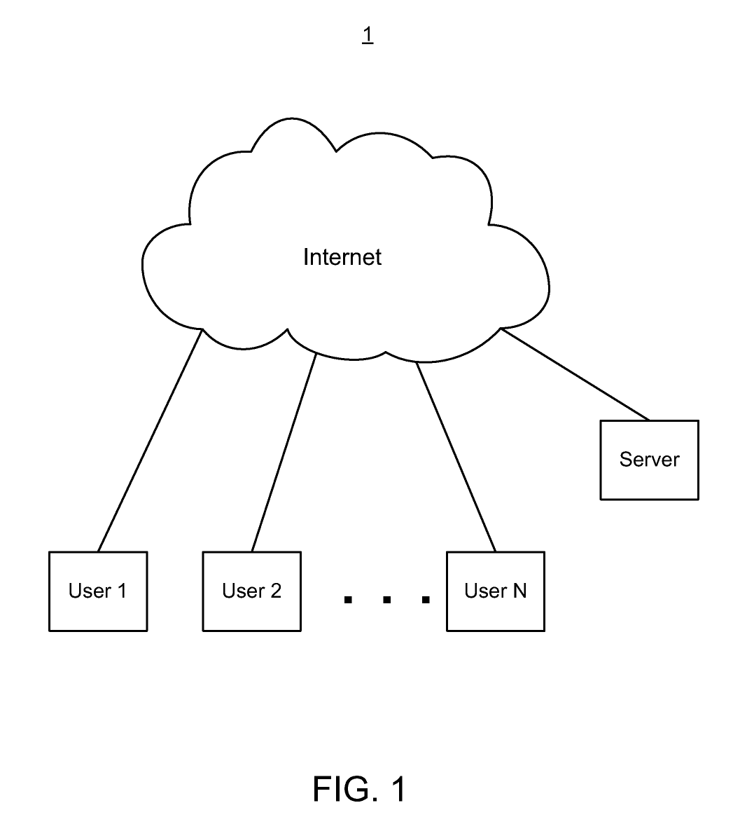

FIG. 1 illustrates a system according to some embodiments of the present invention. As shown in FIG. 1, an exemplary networked system 1 for implementing process(es) according to embodiments of the present invention may include, but is not limited to, a general-purpose computing device that interacts with users through a communications network, such as, but not limited to, the Internet. The computing device may be a server that communicates over a network with user devices, which include, but are not limited to, general-purpose computers, game consoles, smartphones, PDAs, and the like. User devices may communicate with a server through a web site. The user devices may be mobile devices and the web site may be a mobile web site, intended to be accessed through mobile devices. The user devices may communicate with a server or with each other through one or more application s comprising computer-executable instructions.

Although the exemplary system 1 of FIG. 1 involves communication through the Internet, other embodiments may include one or more servers interacting with users through any type of network. Other embodiments may involve peer-to-peer communication between user devices rather than between user devices and a server. Alternate embodiments may not involve a network at all, and may instead be implemented on a standalone device used by the user(s).

The server may be implemented as a network of computer processors. In some implementations, the server may be multiple servers, mainframe computers, networked computers, a processor-based device, and similar types of systems and devices.

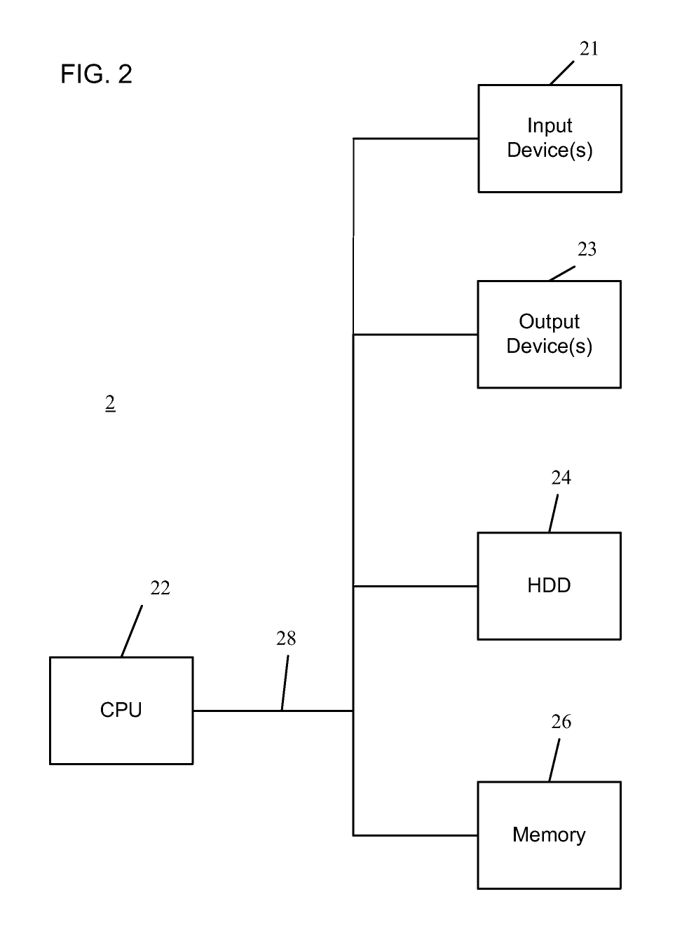

FIG. 2 illustrates a system according to some embodiments of the present invention. As shown in FIG. 2, an exemplary system 2 for implementing the method(s) discussed include (but is not limited to) a general-purpose computing device in the form of a conventional computer, including a processing unit 22 or processor, a system memory 26, and a system bus 28 that couples various system components including the system memory 26 to the processing unit 22. The system may also include input device(s) 21 and/or output device(s) 23. The system memory 26 may include one or more suitable memory devices such as, but not limited to, RAM. The computer may include a storage medium 24, such as, but not limited to, a solid state storage device and/or a magnetic hard disk drive (HDD) for reading from and writing to a magnetic hard disk, a magnetic disk drive for reading from or writing to a removable magnetic disk, and an optical disk drive for reading from or writing to removable optical disk such as a CD-RW or other optical media, flash memory, etc. The drives and their associated computer-readable media may provide non-transient, non-volatile storage of computer -executable instructions, data structures, program modules, and other data for the computer to function in the manner described herein. Various embodiments employing software and/or Web implementations are accomplished with standard programming techniques.

The processor 22 may receive input from one or more input devices 21. An input device 21 may receive input from one or more users or computing devices, and may include (but is not limited to) a keyboard, a pointing device, e.g., a mouse, trackball, or trackpad, a device that senses visual, auditory, or tactile signals (such as a touchscreen), or a device that senses motion. An input device may be part of a computing device (as in the case of a laptop, tablet computer, PDA, smartphone, or the like), or it may be external to a computing device (as in the case of an external keyboard, mouse, remote control, or motion sensor).

The processor 22 may provide output to one or more output devices 23. An output device 23 may provide output to one or more users or computing devices, and may include (but is not limited to) a display such as a CRT (cathode ray tube), LCD (liquid crystal display), plasma, OLED (organic light emitting diode), TFT (thin-film transistor), or other flexible configuration, or any other monitor or display for displaying information to the user. An output device may be part of a computing device (as in the case of a laptop, tablet computer, PDA, smartphone, or the like), or it may be external to a computing device (as in the case of an external monitor or television). In addition, an output device 23 may be any device capable of displaying a web page or outputting information that can be used for the display of a web page. Devices that output information that can be used for the display of a web page include, but are not limited to, networking devices. For example, servers 2 may distribute files (such as those containing HTML) to client computing machines 2 through networking devices 23.

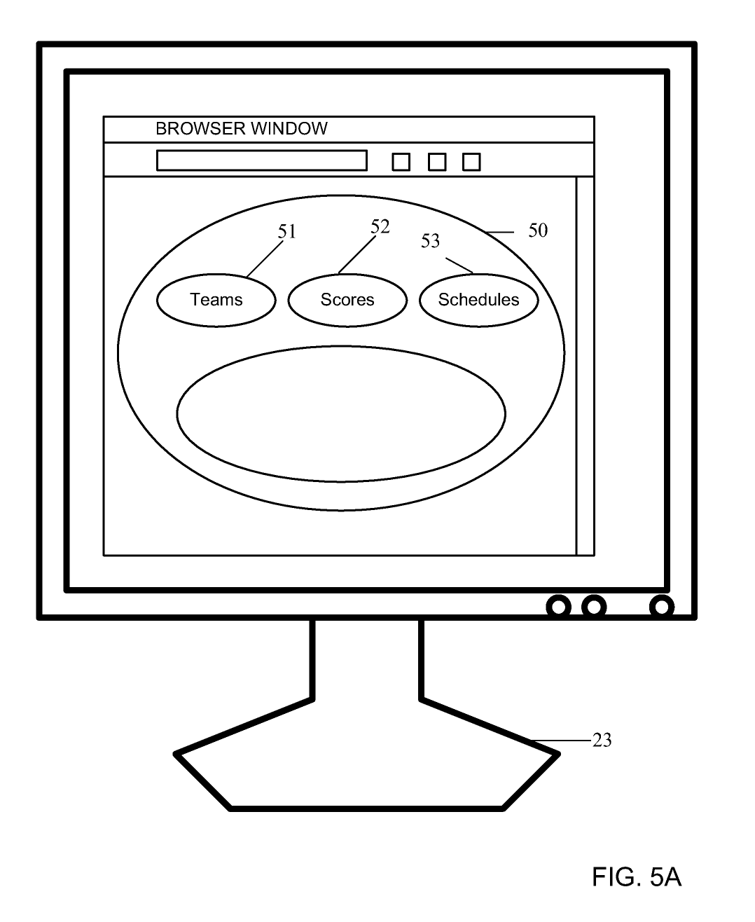

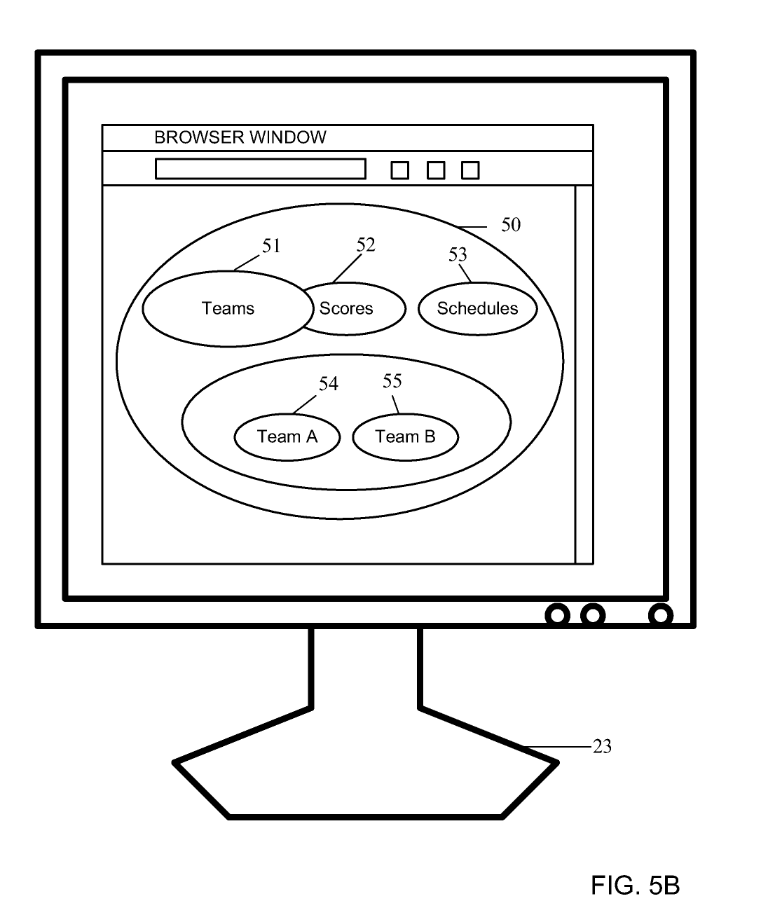

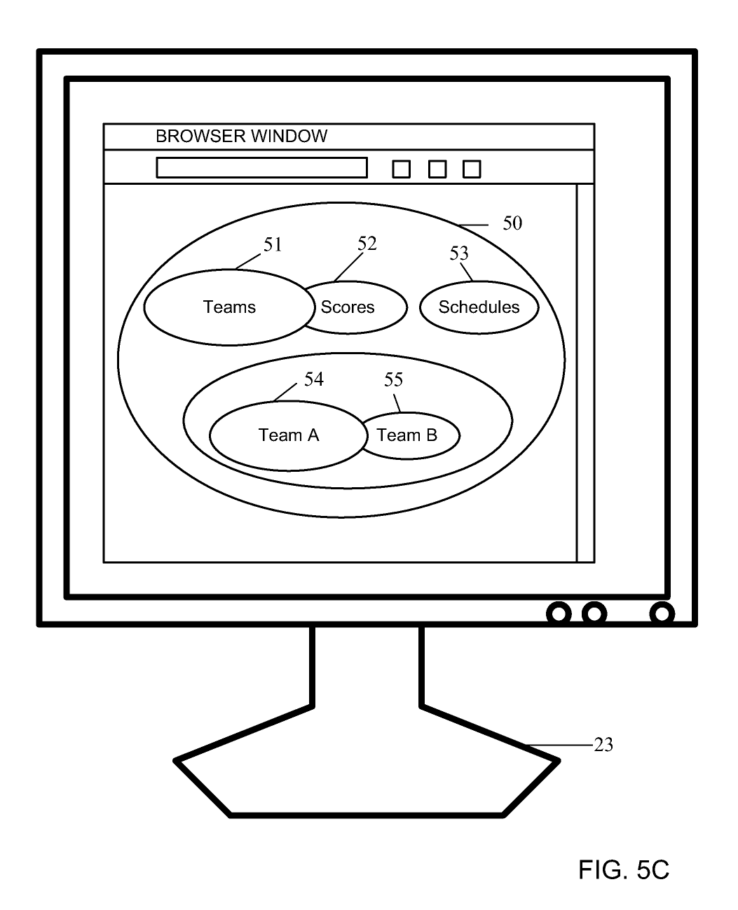

According to various embodiments, computer-executable instructions may encode a process of displaying information. A server may transfer these instructions to a user computing device for execution. The instructions may be executable as a standalone, computer-executable program, by a web browser application (browser), or the like. When executed, the instructions may instruct the computing device to display one or more spatial representations on a display. This is illustrated by FIG. 5A, which shows a computer monitor 23 displaying a spatial representation 50 in an internet browser window, according to an embodiment of the invention.

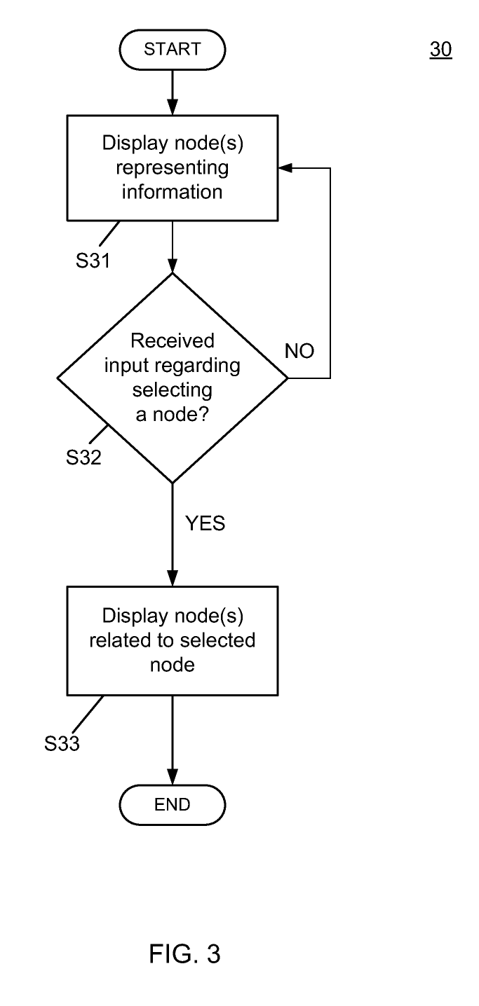

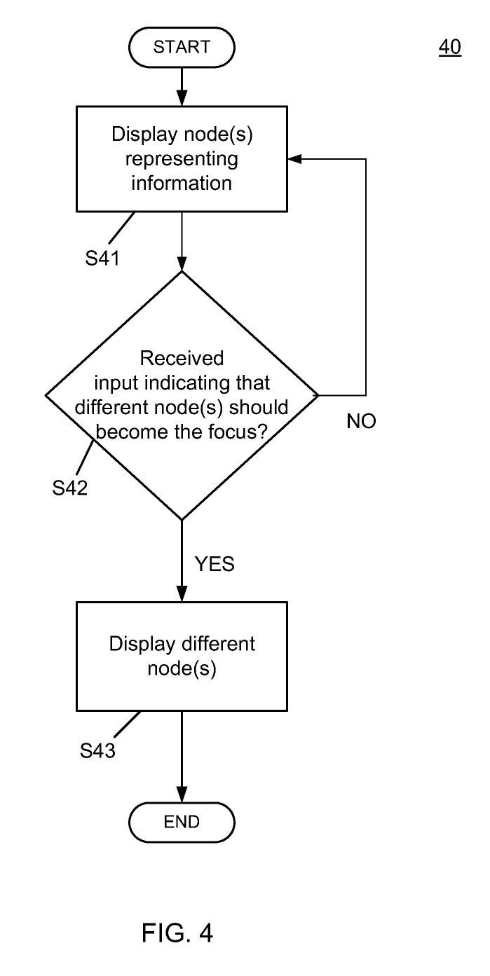

With reference to FIGS. 3 and 4, a method of displaying data according to various embodiments is implemented by the computer system 2 according to processes 30 or 40 as shown in FIGS. 3 and 4. A processor 22 may execute instructions that instruct at least one output device 23 to display a spatial representation 50. In various embodiments, the spatial representation 50 is displayed on a display 23 in a manner according to the processes 30 or 40.

Referring to process 30 of FIG. 3, in step S31, a spatial representation 50 may be displayed on at least one output device 23. The spatial representation 50 may include one or more nodes. A node may be a visual point or vertex in the form of any shape, icon, figure, picture, object, or any other visual representation. Examples of node shapes include circles, ovals, triangles, squares, rectangles, polygons, etc. For example, in FIG. 5A, spatial representation 50 includes nodes 51, 52, 53, which are displayed as ovals. The shape may be a two-dimensional representation of what appears to be a three-dimensional figure, such as a sphere, pyramid, cube, polyhedron, etc. A node may appear to change shape or size or remain the same.

Each node may represent information. Information may include concept(s), text, picture(s), image(s), audio, video(s), statistic(s), document(s), link(s) to other information (such as a World Wide Web link), or the like, or any combination of those. Information may be divided into portions such that each node represents a portion of the information. Each node may represent different information. Alternatively, there may be overlap in the information represented by some or all of the different nodes in a spatial representation 50. One or more nodes may duplicate the information of one or more other nodes.

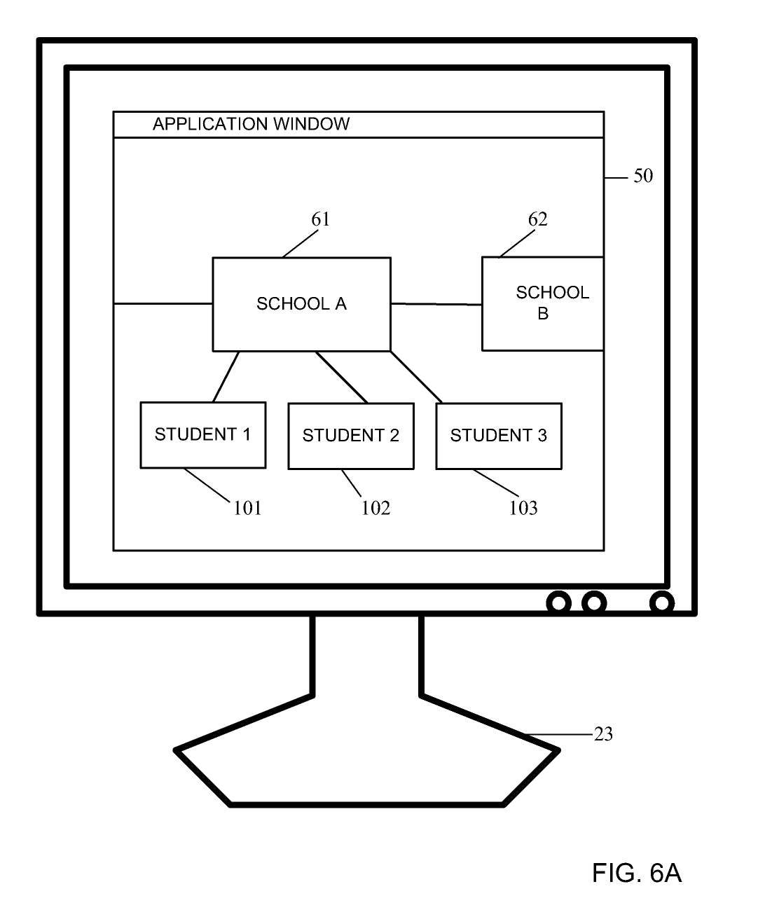

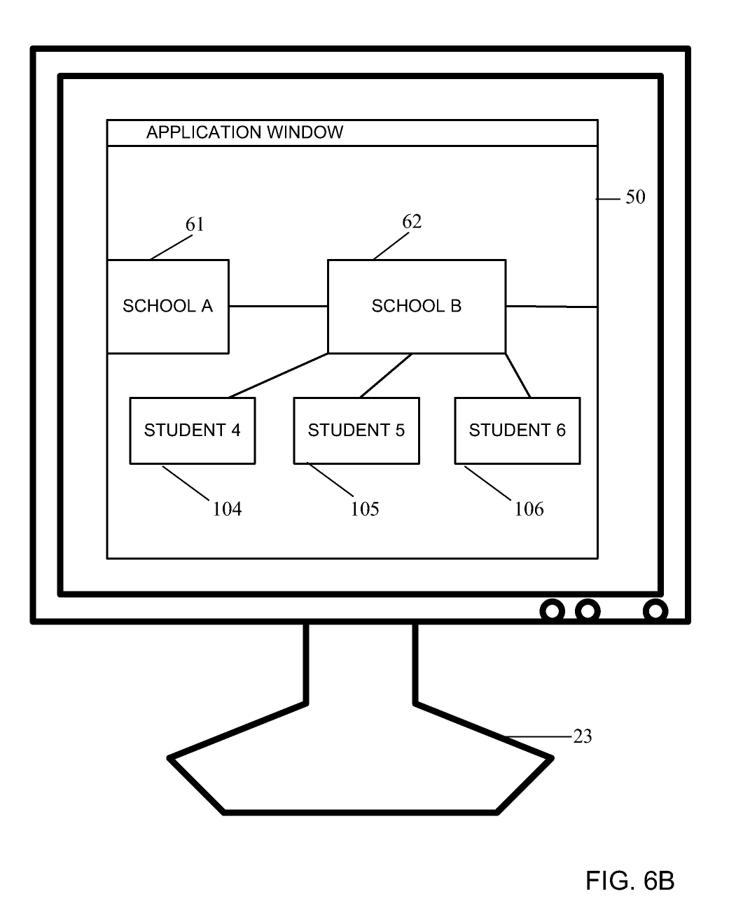

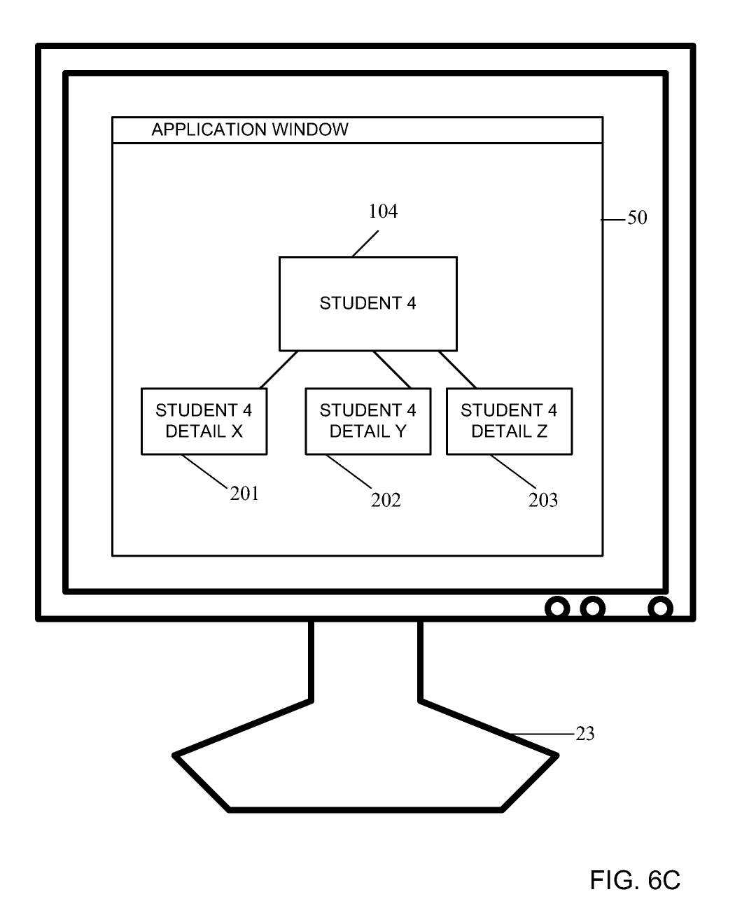

The information represented by nodes may form a hierarchy of information. Information may be organized or divided into portions such that one or more portions may be of a higher or lower level in the hierarchy than one or more other portions. A node representing information higher in the hierarchy may represent something that groups together or relates together the nodes lower in the hierarchy. This is illustrated in FIG. 6A, which shows, according to an embodiment, that node 61 representing School A information is at a higher level in a hierarchy than nodes 101, 102, 103, which represent Student 1, Student 2, and Student 3 information. The student information nodes 101, 102, 103 may be a lower level in the hierarchy than the school node 61 because all three students attend School A. That is, the student nodes are grouped together or related to each other because those students all attend the same school.

Nodes appearing higher in the hierarchy in one view or portion of the spatial representation 50 may appear lower in the hierarchy in another view or portion of a spatial representation 50. For example, in the school and student example of FIG. 6A, the node 61 for School A appears higher in the hierarchy than the node 101 for Student 1. However, node 101 (representing Student 1) may appear higher in the hierarchy than node 61 (representing School A), for example, if the view in the spatial representation 50 shows the list of schools attended by Student 1. For instance, Student 1 may have attended School A and School C. The nodes for School A and School C would then lower in the hierarchy than the node 101 for Student 1. Thus, a node may be both higher and lower than another node in the hierarchy. Also, the same node may be displayed multiple times in the same spatial representation 50. In the Student 1 example, the spatial representation 50 may display the nodes as they are in FIG. 6A, with additional nodes displayed for the schools attended by Student 1. Thus, there may be two nodes displayed for School A, because the spatial representation 50 displays both a list of students of School A and a list of schools attended by one of those students, Student 1.

Information and nodes may be divided into sets and subsets of information such that the information of one node may be included in the node above it in the hierarchy. This is illustrated in FIG. 5B, which shows, according to an embodiment, that node 51 representing team information is higher in the hierarchy than nodes 54, 55, which represent Team A and Team B information. Node 51 may represent information for all of the teams, and thus may represent the information for both node 54 and 55, which are both lower than node 51 in the hierarchy.

Nodes may be displayed anywhere in the spatial representation 50. All nodes in a hierarchy may be displayed, a portion may be displayed, or none may be displayed. Nodes may be made visible or invisible depending on input received from an input device(s) 21. A node may appear to move within or out of the spatial representation 50 or remain stationary. A node may appear as an animation or may remain static. Different nodes may be of differing sizes, shapes, or the like, they may be the same, or some may be the same while others are different. Attributes of nodes, such as their appearance, size, shape, movement, or the like may change depending on input received from an input device(s) 21.

Node(s) or other item(s) in the spatial representation 50 may be arranged in a two-dimensional manner or so that they appear to be in three dimensions. For instance, they may have the appearance that one node is behind another. An example of this is illustrated in FIG. 5B, in which node 52 appears to be behind node 51.

Nodes that are related to each other may appear in the spatial representation 50 to be connected to each other in some manner, or they may not be. For instance, the connection may be illustrated using a line, position, close proximity, or any other representation conveying the idea of relatedness. Similarly, the connection illustration or a similar illustration may or may not convey what level of the hierarchy each node is in relative to the other(s) displayed. FIGS. 6A-6C illustrate examples of nodes that are connected to each other using a line, according to an embodiment. FIGS. 5A-5C illustrate examples of nodes that are not connected to each other using a line, despite any relatedness, according to an embodiment. However, the nodes of FIGS. 5A-5C demonstrate their position in the hierarchy by their relative position. That is, the nodes 51, 52, 53 are aligned in a row because they are at the same level of the hierarchy. Similarly, nodes 54, 55 are aligned in a row because they are at the same level of the hierarchy. However, nodes 54, 55, are displayed in a row lower in the spatial representation 50 because they are lower in the hierarchy than nodes 51, 52, 53.

Returning to FIG. 3, in step S32, a processor 22 determines whether input has been received from an input device or devices 21. The processor 22 may accept input from a user, device, software, or the like. Input from a user or device may include input from a mouse used to hover over, click on, drag, etc. a spatial representation 50, nodes within the spatial representation 50, space within the spatial representation 50, or anything else within the spatial representation 50. Input from a user or device may instead be from a keyboard, such as from the pressing of one or more keys. Input from a user or device may be a result from the touching or dragging of fingers on a touchscreen device. Input from a user or device may be a result from a verbal command, a visual command (such as, but not limited to, from a light sensor, including an infrared sensor receiving a signal from a device such as a remote). Input from a user or device may be a result from a motion sensor that has sensed motion (e.g., the motion of one or more users). The lack of affirmative input may itself indicate input. Input may include one or a combination of the above types of input, or any other type of input that could indicate a user's intent.

If input indicates that a node is selected, then step S33 is executed. Otherwise, step S31 is executed. Alternatively, it may be that more than one node is selected, resulting in step S33 being executed. Input may indicate that a node is selected by specifying one or more nodes, hovering over, touching, dragging, keying in the name of, or otherwise indicating a selection of the node, or the like.

In step S33, a processor 22 may execute instructions that instruct at least one output device 23 to display an updated spatial representation 50 such that node(s) related to those node(s) selected in step S32 are displayed. Node(s) that are related may be closely related, tangentially related, or the like, to the selected node(s). Node(s) that are related may be lower, higher, or at the same level in the hierarchy as the selected node(s). If there are multiple nodes displayed that are related to the selected node(s), these related nodes may or may not be directly related to each other, and they may or may not be at the same level in the hierarchy.

The selected node(s) may appear in the spatial representation 50 of step S33, some may appear, or none may appear. The related node(s) appearing in the spatial representation 50 of step S33 may have appeared in the spatial representation 50 of step S31, some may have appeared, or none may have appeared. The spatial representation 50 of step S31 may be the same as the spatial representation 50 of step S33 but with more node(s), fewer node(s), different node(s), or the like. Alternatively, the spatial representation 50 of step S31 may otherwise be different from the spatial representation 50 of step S33.

Selected node(s) may appear different from the way they previously appeared in the spatial representation 50 of step S31. For instance, the size, prominence, color, icon, or the like may be different. An example of this is illustrated in FIGS. 5A and 5B. In the initial spatial representation 50 shown in FIG. 5A, node 51 is the same size as nodes 52, 53. In FIG. 5B, however, node 51 has been selected, and is then displayed in the updated spatial representation 50 as larger than nodes 52, 53.

Nodes may or may not appear to overlap each other, or they may change to become overlapping or stop overlapping. As illustrated in FIGS. 5A and 5B, node 51 changed to overlap node 52 after node 51 was selected.

Process 30 is illustrated by FIGS. 5A and 5B, which show a computer monitor 23 displaying a spatial representation 50 and an updated spatial representation 50 in an internet browser window, according to an embodiment of the invention. FIG. 5A illustrates step S31, in which the initial version of the spatial representation 50 is displayed. Nodes 51, 52, 53 are displayed in the spatial representation 50. Node 51 represents sports team information, node 52 represents sports score information, and node 53 represents sports schedule information. In this example, nodes 51, 52, 53 represent information at the same level in the hierarchy, but other embodiments may display nodes representing information at more than one level of a hierarchy.

FIG. 5B illustrates that because input has indicated that node 51 is selected, the nodes related to node 51 are displayed in the updated spatial representation 50. Specifically, node 51 represents team information, and node 54 for Team A information and node 55 for Team B information are displayed because the team information was selected due to the indication of node 51 by the input of step S32.

Referring to process 40 of FIG. 4, step S41 is the same as step S31 in process 30 of FIG. 3, except that the following step is step S42.

Step S42 of FIG. 4 is similar to step S32 in process 30 of FIG. 3. However, in step S42, if input indicates that one or more different nodes should become the focus of the updated spatial representation 50, then the next step in the process is step S43. Otherwise, the next step is step S43.

Input that indicates that a different node should become the focus includes, for example, selecting a portion of the spatial representation 50 that is not a node. Alternatively, selecting a region that is on the right, left, top, or bottom side of the spatial representation 50 may indicate that the user wishes to change the view to move in the direction indicated (that is, to “pan” or “scroll” over). That is, move the view or focus toward the right if a region on the right is selected, and so on.

Step S43 is similar to step S33 of process 30 in FIG. 3. However, instead of displaying node(s) related to selected node(s), in step S43, it appears that the spatial representation 50 has “panned” or “scrolled” over from how it appeared in step S41. That is, a different view of the information may be presented, such that it appears that the node(s) have shifted over in the updated spatial representation 50. If a new node or nodes becomes the focus in the updated spatial representation 50, node(s) related to the focus node(s) may or may not be displayed.

Process 40 is illustrated by FIGS. 6A and 6B, which show a computer monitor 23 displaying a spatial representation 50 and an updated spatial representation 50 in an application window, according to an embodiment of the invention. FIG. 6A illustrates step S41, in which the initial version of the spatial representation 50 is displayed. Nodes 61, 62, 101, 102, and 103 are displayed in the spatial representation 50. Node 61 represents school A information and node 62 represents school B information. Nodes 101, 102, 103 each represent the information regarding a student who attends School A. In this example, nodes 61 and 62 represent information at the same level in the hierarchy. Similarly, nodes 101, 102, 103 represent information at the same level in the hierarchy. However, nodes 61 and 62 represent information at a higher level of the hierarchy than nodes 101, 102, 103.

FIG. 6B illustrates step S43, that in the updated spatial representation 50, the focus has changed to node 62, which represents school B. In this example, because the new focus is on node 62, nodes related to node 62 are now displayed in the updated spatial representation 50. Specifically, node 62 represents School B information, and now nodes 101, 102, 103 are displayed, which each represent the information regarding a student who attends School B. This new focus on node 62 and its related nodes is due to the indication in step S42 of that node 62 should become the focus, or that the view should appear to shift toward the right.

Processes 30 and 40 may be used alone, repeated, or used in combination. For example, FIGS. 6A-6C show a computer monitor 23 displaying a spatial representation 50 and an updated spatial representation 50 in an application window, according to an embodiment of the invention. As discussed above, the process 40 was completed, as shown in FIGS. 6A and 6B. Afterward, as shown in FIG. 6C, process 30 is completed, so that it appears that node 104 has been “zoomed in” on in the updated spatial representation 50. That is, the lower-level node 104 has been selected, based on input received, and related nodes 201, 202, 203 are displayed, which are of an even lower level in the hierarchy. That is, the information they represent is at a lower level in the hierarchy than that of node 104.

In some embodiments, the spatial representation 50 is laid out like a three-dimensional map. That is, based on input received, the spatial representation 50 and its updates may portray the appearance of zooming in closer to view more detailed information, or zooming out to view more high-level, general information. Based on input received, the spatial representation 50 and its updates may portray the appearance of navigating to the side, up, down, or in any direction so that information (or nodes representing the information) can be viewed that are related, tangential, or on the same or similar level of the hierarchy.

The information displayed in the spatial representation may update dynamically. The update may occur at any time, at a predetermined time, or in response to input from the user. For example, if the user provides input through an input device 21, then this may cause a spatial representation 50 to change. Information may be streamed, dynamically, from a remote or local database(s) or server(s) for display through the spatial representation 50. Additionally, choices that the user makes may affect the type or content of the information selected for display to the user.

Nodes for popular information may be presented in a spatial representation differently from nodes for less popular information. It may be shown as a different size, more or less prominent, a different color, it may have an indicator displayed on or near it, such as an asterisk, icon, etc., or the like. This is illustrated in FIG. 5C, which shows, according to an embodiment, that node 54 is more popular than node 55, or that the information for node 54 is more popular than the information for node 55. Therefore, node 54 is larger, more prominent, and appears to be in front of node 55. The popularity level of one or more nodes may change at any time, at a predetermined time, in response to input from the user, or in real time. Similarly, the appearance of one or more nodes in the spatial representation 50 may change at any time, at a predetermined time, in response to input from the user, or in real time in response to the change in popularity.

The computer-executable instructions that encode the process of displaying a spatial representation 50 may be written in any programming language that supports an implementation of the present invention. For example, HTML5 (the fifth revision of the Hypertext Markup Language) may be used to encode instructions for rendering the spatial representation 50 and updates to it. The styles of the spatial representation 50 may be encoded in CSS (Cascading Style Sheets) stylesheets. Input events, such as keyboard key presses, mouse input, touch events on a touch-sensitive device, or motion events from a motion sensing device may be encoded using JavaScript.

Browsers supporting HTML5 may be used to execute these scripts and markup, and then send appropriate display data to a display, so that the display will show the spatial representation 50.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein.

The above-described embodiments can be implemented using hardware, software or a combination thereof. When implemented in software, the software code can be executed on any suitable processor or collection of processors, whether provided in a single computer system (“computer”) or distributed among multiple computers.

Further, it should be appreciated that a computer may be embodied in any of a number of forms, such as a rack-mounted computer, a desktop computer, a laptop computer, a server computer, a cloud-based computing environment, a tablet computer, a game console, etc. Additionally, a computer may be embedded in a device not generally regarded as a computer but with suitable processing capabilities, including a Personal Digital Assistant (PDA), a smart phone or any other suitable portable or fixed electronic device.

Various embodiments may include hardware devices, as well as program products comprising computer-readable, non-transient storage media for carrying or having data or data structures stored thereon for carrying out processes as described herein. Such non-transient media may be any available media that can be accessed by a general-purpose or special-purpose computer or server. By way of example, such non-transient storage media may comprise random-access memory (RAM), read-only memory (ROM), erasable programmable read-only memory (EPROM), electrically erasable programmable read-only memory (EEPROM), field programmable gate array (FPGA), flash memory, compact disk, or other optical disk storage, magnetic disk storage or other magnetic storage devices, or any other medium which can be used to carry or store desired program code in the form of computer-executable instructions or data structures and which can be accessed by a general-purpose or special-purpose computer. Combinations of the above may also be included within the scope of non-transient media. Volatile computer memory, non-volatile computer memory, and combinations of volatile and non-volatile computer memory may also be included within the scope of non-transient storage media. Computer-executable instructions may comprise, for example, instructions and data that cause a general-purpose computer, special-purpose computer, or special-purpose processing device to perform a certain function or group of functions.

In addition to a system, various embodiments are described in the general context of methods and/or processes, which may be implemented in some embodiments by a program product including computer-executable instructions, such as program code. These instructions may be executed by computers in networked environments. The terms “method” and “process” are synonymous unless otherwise noted. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

In some embodiments, the method(s) and/or system(s) discussed throughout may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments may encompass many types of computer system configurations, including personal computers, hand-held devices, multi-processor systems, microprocessor-based or programmable consumer electronics, network PCs, minicomputers, mainframe computers, and the like.

In some embodiments, the method(s) and/or system(s) discussed throughout may be operated in distributed computing environments in which tasks are performed by local and remote processing devices that may be linked (such as by hardwired links, wireless links, or by a combination of hardwired or wireless links) through a communications network. In a distributed computing environment, according to some embodiments, program modules may be located in both local and remote memory storage devices. Data may be stored either in repositories and synchronized with a central warehouse optimized for queries and/or for reporting, or stored centrally in a database (e.g., dual use database) and/or the like.

The various methods or processes outlined herein may be coded and executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. The computer-executable code may include code from any suitable computer programming or scripting language or may be compiled from any suitable computer-programming language, such as, but not limited to, ActionScript, C, C++, C#, Go, HTML, Java, JavaScript, JavaScript Flash, Objective-C, Perl, PHP, Python, Visual Basic, and XML.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer-readable medium or media can be transportable, such that the program or programs stored thereon can be loaded onto one or more different computers or other processors to implement various aspects of the present invention as discussed above. The recitation of a module, logic, unit, or circuit configured to perform a function includes discrete electronic and/or programmed microprocessor portions configured to carry out the functions. For example, different modules or unit that perform functions may be embodied as portions of memory and/or a microprocessor programmed to perform the functions.

Additionally, it should be appreciated that according to one aspect, one or more computer programs that, when executed, perform methods of the present invention, need not reside on a single computer or processor, but may be distributed in a modular fashion amongst a number of different computers or processors to implement various aspects of the present invention.

The indefinite articles “a” and “an,” as used herein in the specification and in the claims, unless clearly indicated to the contrary, should be understood to mean “at least one.”

While specific embodiments have been disclosed, the various embodiments are not to be considered limiting. One of ordinary skill in the art will understand that variations and modifications flow from the teachings provided herein.

What is claimed is:

1. A method for displaying information, the method comprising:
displaying, on a display, a first spatial representation of one or more nodes of a hierarchy of information, the first spatial representation comprising a first node;
receiving, at a processor, input;
displaying, on the display, a second spatial representation of one or more nodes of the hierarchy of information, based on the input;
wherein the second spatial representation comprises a second node, which represents information that is related to information represented by the first node.

2. The method of claim 1, wherein the second node is not displayed in the first spatial representation.

3. The method of claim 1, wherein the second node represents information that is at a different level of the hierarchy than the information represented by the first node.

4. The method of claim 3, wherein the input comprises selecting the first node.

5. The method of claim 1, wherein the second node represents information that is at a same level of the hierarchy as the information represented by the first node.

6. The method of claim 1, wherein, whether each node of the one or more nodes is displayed in the first spatial representation is determined based at least in part on (a) how closely related the information represented by each node is to the information represented by the first node or (b) the popularity of information represented by each node.

7. The method of claim 1,
wherein a size or prominence of the first node in the first spatial representation depends at least in part on a popularity level of the information represented by the first node; and
wherein the size or prominence of the first node changes as the popularity level changes.

8. A computer system for displaying information, comprising:
memory hardware storing program instructions, and one or more processors in data communication with the memory hardware and configured to execute the program instructions, and upon execution the program instructions cause the one or more processors to perform operations comprising:
providing display data representing a first spatial representation of one or more nodes of a hierarchy of information, the first spatial representation comprising a first node;
receiving, at a processor, input;
providing display data representing a second spatial representation of one or more nodes of the hierarchy of information, based on the input;
wherein the second spatial representation comprises a second node, which represents information that is related to information represented by the first node.

9. The computer system of claim 8, wherein the memory hardware is located on one or more servers that transfers the program instructions to a client computing device for execution.

10. The computer system of claim 8, wherein the second node is not displayed in the first spatial representation.

11. The computer system of claim 8, wherein the second node represents information that is at a different level of the hierarchy than the information represented by the first node.

12. The computer system of claim 11, wherein the input comprises selecting the first node.

13. The computer system of claim 8, wherein the second node represents information that is at a same level of the hierarchy as the information represented by the first node.

14. The computer system of claim 8, wherein, whether each node of the one or more nodes is displayed in the first spatial representation is determined based at least in part on (a) how closely related the information represented by each node is to the information represented by the first node or (b) the popularity of information represented by each node.

15. A tangible computer-readable medium having instructions encoded thereon, wherein the instructions when processed by a processing circuit perform the following:
displaying, on a display, a first spatial representation of one or more nodes of a hierarchy of information, the first spatial representation comprising a first node;
receiving, at a processor, input;
displaying, on the display, a second spatial representation of one or more nodes of the hierarchy of information, based on the input;
wherein the second spatial representation comprises a second node, which represents information that is related to information represented by the first node.

16. The tangible computer-readable medium of claim 15, wherein the second node is not displayed in the first spatial representation.

17. The tangible computer-readable medium of claim 15, wherein the second node represents information that is at a different level of the hierarchy than the information represented by the first node.

18. The tangible computer-readable medium of claim 17, wherein the input comprises selecting the first node.

19. The tangible computer-readable medium of claim 15, wherein the second node represents information that is at a same level of the hierarchy as the information represented by the first node.

20. The tangible computer-readable medium of claim 15, wherein, whether each node of the one or more nodes is displayed in the first spatial representation is determined based at least in part on (a) how closely related the information represented by each node is to the information represented by the first node or (b) the popularity of information represented by each node.
